(19) United States
(12) Patent Application Publication
(10) Pub. No.: US 2006/0233926 A1
(43) Pub. Date: Oct. 19, 2006

(54) Method for reducing cancer stimulating compounds in cow's milk

(76) Inventor: Robert D. Bibb, Myrtle Beach, SC (US)

Correspondence Address: Robert D. Bibb, M.D., 7554 Siena Blvd., Myrtle Beach, SC, 29572, US

(21) Appl. No.: 11/104,372

(22) Filed: Apr. 13, 2005

(51) Int. Cl. A23L 3/00

(52) U.S. Cl. 426/248

(57) ABSTRACT

A method for reducing cancer stimulating compounds in cow's milk.

### 1. FIELD OF THE INVENTION

The present invention relates generally to electromagnetic spectra irradiation and ionizing irradiation of cow's milk and includes but is not limited to ultraviolet light, infrared light, ultrasound, ionizing radiation and other physical processes that destroy the chemical bonds of any and all cancer stimulating substances in cow's milk, and more specifically, it relates to a process for reducing cancer stimulating compounds in cow's milk. These same naturally occurring compounds in cow's milk are suspected to have negative health effects in humans.

### 2. BACKGROUND OF THE INVENTION

It can be appreciated that ultraviolet light irradiation of cow's milk was the method of choice to create vitamin D beginning in the mid nineteen twenties until the early nineteen fifties. This process was abandoned then because it became possible to create vitamin D synthetically. The elimination of the ultraviolet light irradiation of cow's milk appears to coincide with an increase in the incidence of certain types of human cancers.

Epidemiological research suggests a correlation between milk consumption and at least two kinds of cancer: breast and prostate. A comparative study published in 1989 showed that in Europe, two areas with higher milk consumption-Scandinavia and the Netherlands, also had higher breast cancer rates.

Although ultraviolet light irradiation of cow's milk is not new, the prior art was used solely to generate vitamin D in situ, whereas my invention claims to reduce the sterol ring structure of certain androgenic and estrogenic compounds as well as destroying the structure of other biological compounds capable of stimulating cancer growth and includes but is not limited to such compounds such as insulin-like growth factor one, epidermal growth factor, transforming growth factor beta and prostate specific antigen and makes no claims concerning vitamin D nor its formation.

### SUMMARY OF THE INVENTION

The process will consist of an ultraviolet light source or other electromagnetic device or ionizing irradiation device with adequate radiation intensity, dwell time and surface exposure to break the sterol bonds of the cyclical compounds comprising the androgenic and estrogenic sterol compounds and to destroy the chemical structure of other cancer stimulating compounds in the cow's milk or other materials derives from cow's milk such as cheese, ice cream, butter and yogurt. The reduced entities will then be digestable by the normal human gut. I claim my device to be all designs that can be placed in any area of the milk processing line up to and including final bottling, in-transit shipping and on the retail shelf staging.

### DETAILED DESCRIPTION OF PREFERRED EMBODIMENTS

The present invention is a new process for destroying compounds In cow's milk suspecting of stimulating certain human cancers. The process consists of inserting on ultraviolet light or other electromagnetic emitting device in the processing line for preparing cow's milk for human consumption. With respect to the above description then, it is to be realized that the optimum operational relationships for the process of the invention, to include variations in size, materials, shape, form, function and manner of operation, assembly and use are deemed readily apparent to one skilled in the the art and all equivalent relationships to those described in the specification are intended to be encompassed in the present invention.

Therefore, the foregoing is considered as illustrative only of the principles of the invention. Further, since numerous modifications and changes will readily occur to those skilled in the art, it is not desired to limit the invention to the exact operation described above and accordingly, all suitable modifications and equivalents may be resorted to, filling within the scope of this invention.

What is claimes is:

1. That I have invented a process utilizing ultraviolet light or other physical modalities that inactivate the compounds in cow's milk suspected of stimulating certain human cancers.
